(19) United States
(12) Patent Application Publication
(10) Pub. No.: US 2005/0010493 A1
(43) Pub. Date: Jan. 13, 2005

(54) Information disclosure and contracting method for the demander of distributed power supply business

(75) Inventor: Shigeaki Namba, Hitachi (JP)

Correspondence Address: MATTINGLY, STANGER & MALUR, Suite 370, 1800 Diagonal Rd., Alexandria, VA, 22314, US

(73) Assignee: Hitachi, Ltd.

(21) Appl. No.: 10/915,424

(22) Filed: Aug. 11, 2004

Related U.S. Application Data
(63) Continuation of application No. 09/933,043, filed on Aug. 21, 2001.

(30) Foreign Application Priority Data
Mar. 9, 2001 (JP) 2001-065975

(51) Int. Cl. G06F 17/60

(52) U.S. Cl. 705/26

(57) ABSTRACT

An information apparatus of a demander is connected via a communication line to an information apparatus of a power company or enterprise. When a power supply contract is signed between the enterprise and the demander, the enterprise presents information of contract (start) periods and information of a unit price of charge for each contract period. According to the information, the demander sets a customized pattern (load pattern) for each desired one of the periods and sends the pattern to the enterprise. The enterprise presents information of charge for the load pattern. The demander determines a power supply contract for the periods. In the operation, the demander collates the load pattern at a present time with a load pattern in a predetermined period in the past and re-sets values of the load pattern at the present time. The enterprise presents information of charge for the load pattern modified and set by the demander.

### BACKGROUND OF THE INVENTION

1. Field of the Invention

The present invention relates to an information disclosure and contracting method for the demander (including a consumer) of distributed power supply business, and in particular, to an information disclosure and contracting method, for use in a case in which a company or an enterprise to supply power to power demander using distributed power supply carries out the business using power transmission lines and/or power distribution lines of existing power companies, the method being used to supply charging information when the company makes services for power demanders, the method being used for a new contract and for update of an existing contract.

2. Description of the Related Art

Recently, in one aspect of a method of disclosing information to load demanders of power transmission and distribution systems in Japan, it has been commonly known that charging information is controlled to suit convenience of the power supplying side. That is, an electric power company of each region in Japan employs a method to basically close information only within the power transmission network by aiming at optimization of an enterprise assuming monopolistic management which is quite strongly combined with the public interest in the region and at own stable power supply which can be achieved by the enterprise. There consequently exists predetermined restrictions in which any power demander in the region of the power company must receive power supplied from the power company in the pertinent region in any situation if the power demander has not own power generator. Under the condition as the assumption, the power company has been in a situation that the company can use a charging system for the demanders in which the system is configured to suit convenience of the business processing of the company. This method is commonly characteristic particularly in basic, public industries and the like in Japan. For a utility supply system directly related to the life of the people, the method is sufficiently appropriate also in consideration of legislation because high reliability and guarantee of safety are quite important.

According to the recent world trends of deregulation, the charging system of electric power companies in Japan become slightly flexible. For example, the Tokyo Electric Power Co., Ltd. discloses information in its homepage via the internet (Aug. 19th, 2000) as follows.
(1) “100% for two highest input facilities selected from the contacted load facilities, 95% for two subsequent highest input facilities, and 90% for other facilities”
(2) Of the total value obtained according to (1), 100% for first 6 kilowatt (kW), 90% for next 14 kW, 80% for next 30 kW, and 70% for those exceeding 50 kW.

That is, the contracted electric power is represented by a value obtained by multiplying the coefficients of (2) by the total value obtained by multiplying the coefficients of (1). Moreover, the power rate is determined according to two categories, i.e., Summer and other seasons. These are not determined by assuming the small-sized power generating unitary capacity as compared with the size of the ordinary power company using distributed power supply. In consequence, the method can be regarded as inevitable on the operating side of the social system which is totally responsible for electric power generation, transmission, and distribution.

### SUMMARY OF THE INVENTION

However, an object to be discussed is as follows. In the age in which the established electric power utility operating system which was also a national policy must be changed in consideration of the world trends of environmental problems and saving of resources as well as in the worldwide framework called “globalization”, it is necessary to cope with the change. In other words, the object resides also in that how the operating system regarding electric power matches with waves of increasing functionality of electronic apparatuses represented by personal computers and the developing information society existing in the background. Particularly, since there appears a situation in which introduction of the distributed power supply is positively enhanced to be incorporated in the existing electrified society, the object resides in that how rationally a concrete countermeasure is to be provided by harmonizing the countermeasure with economic principles. That is, a system construction plan must be proposed in consideration of up to advantages of demanders as end users.

Additionally, the basic idea of the trend also matches the principle of the Kyoto Conference (Third Conference of Parties to the United Nations Convention on Climate Change) for worldwide environmental protection. That is, the trend of uninterrupted growth of power consumption has been used as assumption to produce a power resource facility plan of the subsequent year. The basic idea above also indirectly matches with the restriction of carbon oxide emission as a countermeasure for prevention of global warming which attracted attentions as the atmospheric environmental problem as well as with the saving of resources of the earth.

Description will now be given of solutions for the problems regarding the difficulties described above. Heretofore, the large-sized power generating facilities of the existing electric power companies are dominant and power transmission loss does not attract any particularly attention. Such an age of uninterrupted-expanding stable operation conducted by assuming the demand in the economic environment which basically, uninterruptedly increases in quantity has been changed into a new age. In the change of situation, the demand is saturated and construction of new power facilities is restricted in consideration of the saving of resources. Advent of the age in which by introducing distributed power supply, the distance between the power generating location and the power consuming location is remarkably minimized makes it necessary to develop a system adaptable for the trend of application of information apparatuses which can appropriately reflect the rational judgement and intentions of demanders. That is, a new system is required to be developed. The system must provide usability such that when an human operator uses an electronic information processing apparatus of low power consumption, the operator feels easiness, not inconvenience and/or the operator feels that he or she can obtain results greater than his or her effort conducted for the results; even if the operator is not versed in the handling of the information processing apparatus, contents to be naturally obtained can be supplied, in response to ordinary thinking power, stage, and procedures regardless of the social position of the operator; at an appropriate point of time. Moreover, the system must be beforehand set so that the user notifies the judgement and intentions of the user to the supplying side.

The object of the present invention, which has been devised to remove the problems above, is to provide a rational information disclosure and contracting method regarding the electric power utilization contract between the distributed power supply business and the power demander.

To achieve the object above according to the present invention, there is provided an information disclosure and contracting method for a demander of a power company or enterprise of distributed power supply business in which the enterprise operates a business by selling electric power to each power load demander via power transmission and distribution lines of existing power companies and dedicated lines dedicated to the business, comprising the steps of connecting an information apparatus of said demander via a communication line to an information apparatus of said company of distributed power supply business, presenting by said enterprise, when a power supply contract is signed between said enterprise and said demander, information of contract (start) periods and information of a unit price of charge for each said contract period, setting by said demander a customized pattern (load pattern) for each desired one of said periods according to the information and sending the pattern to said enterprise, presenting information of charge for said load pattern from said enterprise to said demander, and determining by said demander a power supply contract for said periods.

In accordance with the present invention, the information disclosure and contracting method further comprising the steps of collating by said demander said load pattern to be set at a present time with a load pattern in a predetermined period in the past, re-setting values of said load pattern at the present time, and sends said load pattern to said enterprise, and presenting, from said enterprise to said demander, information of charge for said load pattern modified and set by said demander.

In accordance with the present invention, the information disclosure and contracting method further comprising the steps of setting by said demander, for said load pattern to be set at a present time, a modified pattern for time zones or periods in which a large difference exists for a unit price of charge and sending the modified pattern to said enterprise, presenting, from said enterprise to said demander, information of charge for the pattern modified and set by said demander and supplying, from said enterprise to said demander, information of difference of charge with respect to a charge. (assumed) according to a direct contract with an existing power company.

Next, before explaining an embodiment of the present invention, description will be given of a background and a basic concept of the present invention.

In the background of the present invention, the economic principle is applied when a charge contract is signed between an electric power supplier using distributed power generation and a demander of electric power. First, a primary assumption will be described. When making an electric power sales contract with the demander, the electric company of distributed power supply emphasizes an economic advantage by comparing various contracts between the existing electric power companies and demanders. However, this is not limited only to the reasonable, fixed unit price. Assuming that the unit price varies depending on the relationship between supply and demand, the company strongly explains the demander that the contract is resultantly quite advantageous when compared with those of the existing electric power companies. There exists a recent example in which an existing electric power company developed a contract system of reduced charge for midnight electric power and provided the system to demanders as end users. To cope with such a system, the electric power company or enterprise of distributed power supply (to be simply referred to as “enterprise” herebelow) assumes that the charging system of a electric power company responsible to the pertinent region has been known partially including estimation, and discusses contents of the contract with the demander side according to a correlation between the known charging system with the own power supply cost. When determining a strategy, tactics, and/or a plan for the business, the enterprise sets a charging system by paying attention to a break-even point related to a load rate (facility operating rate). In setting the charge system, there are employed two components including a fixed component and a variable component changing according to the economic principle. This also includes a case in which the charge system depends entirely on the variable component. It may be expected that the business profit is obtained from the fixed and variable components or from ether one thereof, for example, the variable component.

The basic concept of the present invention is as follows. For convenience of explanation, description will be given of an example of a contract with a demander on assumption that the fixed income from big demanders for 50% of the output is canceled with the cost and the income from small demanders corresponding to the remaining 50% of the output is the profit. The contract is signed for a situation when the enterprise satisfies the variable demand of the small demander with the 50% of the output.

If the small demander is a member of a general family or the like, it is natural that the member is not an expert of the information machines and equipment, information items supplied from the machine side are display contents like those supplied from an automated-teller machine (ATM) including information items of the operation procedure guidance. The contents displayed on the information apparatus are to be specifically determined according to the contract with the enterprise, and there arises an economic advantage as a result. That is, the apparatus displays that the charged amount is smaller than that resultant from the charge system of the existing electric power company and the different value between the charged amounts. Thereafter, several cases are examined for the demander to check advantages and the like. All items in a range in which the demander can check the advantages are confirmed, and the items desired by the demander are presented for the contract. By receiving a contract confirmation from the supplier side, the contract operation is terminated.

A more specific case will be described. Assume that a person A working in a firm jobs in a local place and is living in a rented house, leaving his family members. The person A weekends with the family members, that is, he lives in the rented house only weekdays. Therefore, the electric power consumption pattern of the rented house includes a pattern in which the load changes in an almost fixed pattern from Monday to Friday, namely, when the person A stays in the house from the night of a day to the morning of the next day and a pattern in which electric appliances for family use are in a standby state when the person A is out and hence the load changes according to a fixed-load pattern.

The person A desiring to rationalize the living expenses of every month signs, with an electric power company B of distributed power supply, a contract in a precise manner for his own load demand of the second next month. Consequently, assuming that the pertinent month is April, when examining a monthly load pattern of June, the person A displays a contract menu of the company B and a load demand change in actual results of June of last year on a screen of a personal computer. Assuming that only the power consumption of a high-performance air conditioner recently purchased is to be taken into consideration of the actual reduction of load, the person A forms an expected pattern by minimizing 10% of the actual results of June of the last year and provisionally sets the pattern on the screen of the personal computer. The system collates the pattern with an effective load pattern charging condition supported by the power company B at the point of time, calculates an expected charge of the pertinent month (June), and displays the expected amount of charge. In this situation, it is also possible to display an actual charged amount of June of the last year, a charged amount in the previous month, i.e., March; a charged amount assuming a contract with an electric power company in the pertinent region, and an amount representing the difference between the charged amount and the charged amount of the electric power company. This accordingly makes it possible to confirm an advantage resultant from the effort made for the purpose. Furthermore, there is assumed a day in which the person A receives unexpected visitors such that a contract limit load is possibly exceeded and hence the charged value may be increased due to a penalty as a result. Since the charge can also be calculated in this case, the system has been prepared such that it is necessary to pay attention also to consideration of estimation of the actual difference with respect to the budget.

For the power load consumption pattern once determined as described above, there may be a case in which a long-period business trip takes place (the person A is absent from the rented house) immediately before the pertinent contract month and hence it is beforehand understood that the pattern is considerably lower than the expected pattern. In such a case, assuming that the point of time is about the end of May, it is possible that the calculation and the contract are carried out again according to a charge pattern data of June of the company B valid at the point of time. The charge pattern data in this situation is associated with the next month, which comes soon, and hence is an element for the company B to change the expected power generation. In common practices of business, it is possible to explain that to change the expected power generation, the cost for the change naturally appears, and hence the charge is set in a slightly higher level. Conversely, since it is difficult for the company B in this situation to guarantee upper margin of the facility operating rate, there may be adopted, in consideration of the flattening or averaging of the load, a change unnecessary service in which the change of charge condition is not necessary.

As above, that the power demander can set a rational mode of power consumption according to own decision of the demander to suppress the expenditure as well as the financial advantage are important also as a factor to live an independent social life. On the other hand, if results obtained by collecting many different patterns of power consumption modes of respective power demanders are within the total load pattern assumed by the company B, the company B can also acquire, as electronic information, data to discuss the profit calculation thereof and service providing tactics for demanders as customers. Moreover, the data can be used without any long delay and hence this can be regarded as rational also in consideration of management information.

### BRIEF DESCRIPTION OF THE DRAWINGS

The objects and features of the present invention will become more apparent from the consideration of the following detailed description taken in conjunction with the accompanying drawings in which:

FIG. 1 is diagram showing an example of a configuration of an existing electric power company and general power demanders when an electric power company of distributed power supply is introduced according to the present invention;

FIG. 2 is a diagram showing a flow of a contract of a power utilization plan in an embodiment of the information disclosure and contracting method for the demander of distributed power supply businesses according to the present invention;

FIG. 3 is a diagram showing a flow to set data and a flow to create reference actual resultant values according to the present invention;

FIG. 4 is a diagram showing data communication lines between the enterprise and demanders and a tool for data communication according to the present invention;

FIG. 5A, FIG. 5B are a diagram to explain a dedicated tool according to the present invention;

FIG. 6 is a diagram to explain a time limit to set a determined (fixed) load pattern according to the present invention;

FIG. 7 is a diagram showing a load pattern associated with spot supply according to the present invention;

FIG. 8 is a diagram showing a load pattern of a combination of determined supply and spot supply according to the present invention;

FIG. 9 is diagram showing a pattern in which an individual contract is not required according to the present invention;

FIG. 10 is a diagram showing return of a contract from a user (demander) to the enterprise and a summary of information returned according to the present invention;

FIG. 11 is a diagram to explain a charge settlement method according to the present invention;

FIG. 12 is a diagram showing patterns of loads accumulated on the enterprise side according to the present invention;

FIG. 13 is a diagram to explain the setting of spot prices according to the present invention;

FIG. 14 is a diagram to explain the setting of changing spot prices according to the present invention; and

FIG. 15 is a diagram to explain the acquisition of actual result data of power consumed by a demander according to the present invention.

### DESCRIPTION OF THE EMBODIMENTS

Referring now to the drawings, description will be given of an embodiment of the present invention.

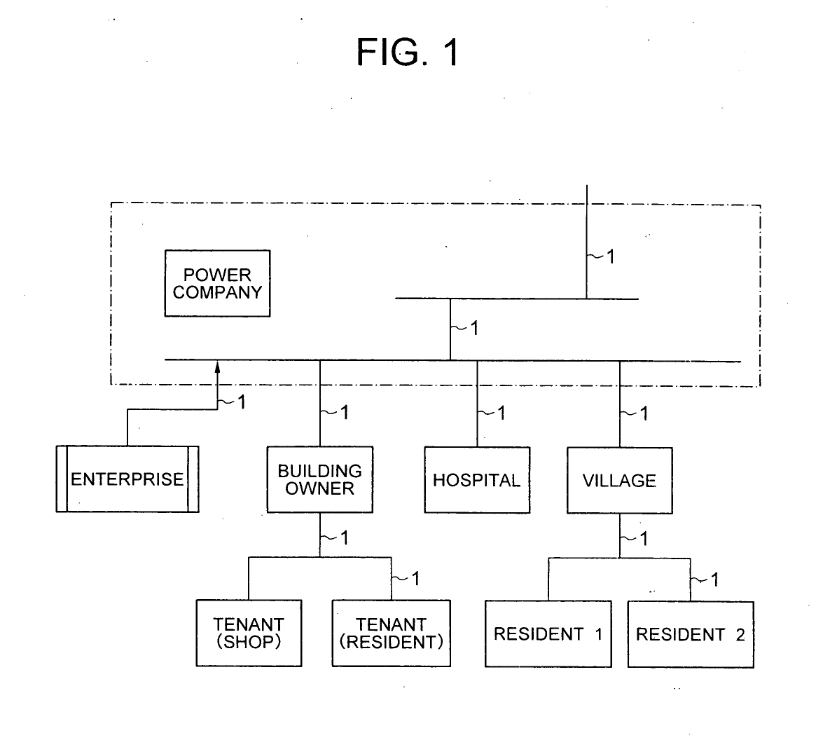

FIG. 1 shows an example of a configuration of an existing electric power company and general power demanders when an electric power company of distributed power supply is introduced according to the present invention. The configuration example includes an electric power company in a predetermined region, an electric power company of distributed power supply (to be abbreviated simply as “enterprise”), an owner of a building, tenants as shops or the like, and tenants as persons who rents rooms thereof, a hospital, and residents or persons 1 and 2 living in an a zone (to be referred to as “village”) in which a plurality of families live such as a housing complex in a region.

FIG. 1 schematically shows power transmission routes in which, for example, the enterprise transmits electric power to a power transmission line 1 of the power company, the power company sends power via the power transmission line 1 to a distribution line 1 of each power demander. The enterprise may use a dedicated line as a route to transmit power to each power demander. In this description, a certain amount of power consumption is assumed, and the volume of consumption is not at a consumption level of a general family. That is, the assumed consumption level is at least several times of that of the general family, namely, on the order of 10 kW or 100 kW. However, as shown in FIG. 1, it is also within the scope of the present invention that it is in principle possible that the operation can also be conduced in each terminal unit at the level of a shop of a tenant and/or at a level of each person living in the room.

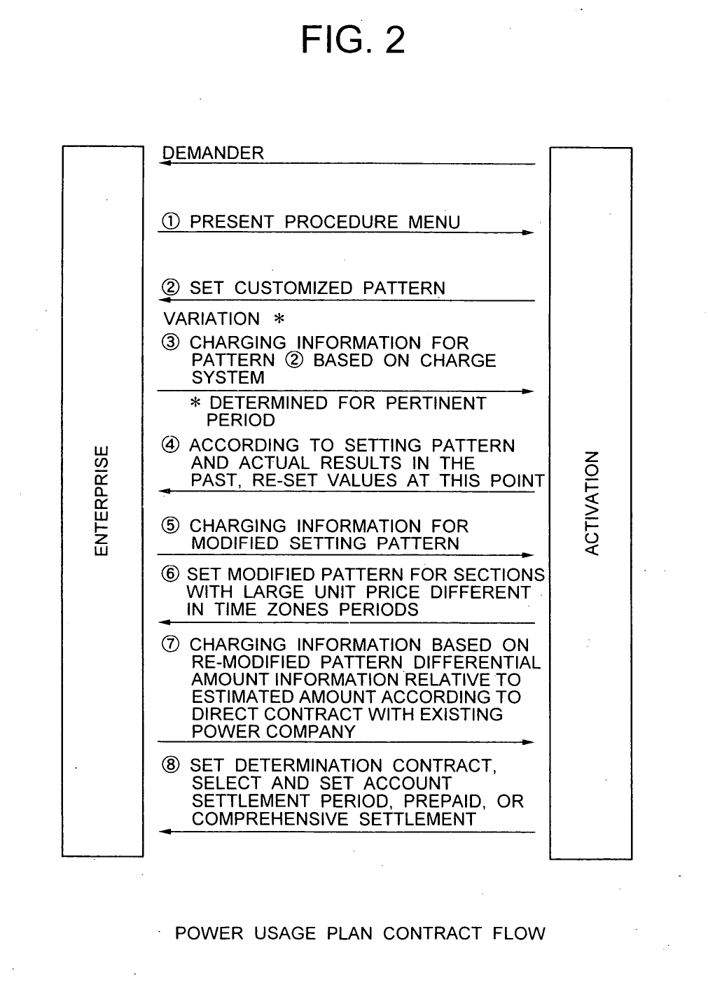

FIG. 2 is an embodiment of the information disclosure and contracting method for the demander of distributed power supply businesses according to the present invention and shows a procedure (a flow to contract a power utilization plan) showing flows of representative information items to sign a contract to set a load pattern between the enterprise and a demander.

Assume that the enterprise is equipped with infrastructure to conduct, between the enterprise and the demanders, communications of respective data via a communication line of a telephone company, a communication line possessed by an electric power company, or the like. The infrastructure includes personal computers of the demanders and data processing terminal tools, which will be described later. Assuming that the demanders has already signed a basic power utilization contract with the enterprise, description will now be given of a process to determine a mode or pattern to purchase or to utilize electric power.

First, the demander activates the information apparatus to establish a communication line to conduct bidirectional data communication. Assume that the demander prepares a support system which displays a screen indicating a procedure to communicate information necessary for the mutual contract so as to comprehensively summarize the entire operation from the start to the end of operation on the demander side. This is a requirement to construct a user-friendly system operable regardless of proficiency of the demander for electronic apparatus operation.

<1> After the procedure is confirmed, the demander displays a menu presented by the enterprise at the point of time. “At the point of time” implies that there exists a chance that the unit power price is changed in the time difference or in the difference of period from the contracted point of time to the contract period (start point). This is conducted for the following reason. When the enterprise considers that the generating power is to be determined at an early point of time for the operation plan of power generating facilities, there exists a background of management statistics to increase demand for electric power of the demanders by providing a relatively low unit price of power. In a situation in which the contract period (start point) is at hand, this is an inevitable action to minimize adjustment margin on the enterprise side.

<2> By the display of the menu, it is possible for the demander to examine a desired pattern. Basic items to be displayed on the menu include a unit power price according to electric power (current) for each contract period. For example, for two months of July and August, it is assumed that there exists high demand, and hence there is displayed information in which an extra charge rate is set to a high value particularly for time zones in the daytime. To cope with a life pattern and a utilization pattern of the demander, there is conducted guidance which enables the demander to select a mode by combining a daily contract period with a weekly contract period. Additionally, at the same time, information items of the charge and the unit price of the respective periods are also displayed. Having generally recognized the basic information above, the demander sets a pattern of desired power consumption to a desired period. In this specification, the pattern is called “customized pattern”. By using the unit price information calculated according to the menu described above, the charge value can be calculated on the demander side, and the demander sends information of the customized pattern to the enterprise side.

<3> As a method to prevent any trouble, it is in this case preferable to use a charge value presented from the enterprise side. Although the charge value may be presented by software installed in the information apparatus, the software must be updated each time the unit price is changed by the enterprise side. Since the demander can obtain the unit price information displayed in the menu and the charge value in the customized pattern, judgement can be conducted according to contents and constitution of the charge value. In a case in which the demander considers that the present charge value is high, the demander can understand which one of the components is to be minimized to efficiently reduce the total charge value.

<4> The minimum level of intentions on the demander side can be determined in this stage. In the embodiment, furthermore, it is possible to collate actual results of a predetermined period in the past. Changes in the trend of power consumption in management categories such as an individual, a family, a building, and the like are important judging elements for persons in charge of expenditure respectively for the individual, the family, the building, etc. Excepting a large-sized power company, this does not come to the surface in the charging system and the charging method of the prior art and is a potential demand for demanders of the small-power distributed power supply. Therefore, in the embodiment, it is possible to clearly presents the potential information need to the demanders. That is, since a demander who has just signed a power utilization contract has not sufficient data accumulated up to this point of time, it is impossible to support a service to supply information for all periods which the demander desires to set. However, for a demander having accumulated data for a predetermined period of time, since information of actual consumption of each demander can be stored as electronic information, it is possible to present also results of charge values in the past to the demander. Although it is also possible to discuss that the information is provided without charge or this service is included in the basic contract, the service is assumed to be included in the basic contract in this description.

Description will be given of a case in which an unmarried demander sets data in the operation according to a pattern of actual load in an associated period of the last year and the charge value of the period. Assume that the demander is working in a firm and the contents of his job are changed due to influence of the reformation of the organization in the firm. His daily life pattern is also changed and he must go to the office early in the morning at present. When the time zone for housework such as preparation for breakfast in the independent life becomes two hours earlier than before, the pattern of power consumption of each week day is changed such that the two-hour shift takes place in the morning pattern. As a result, the power consumed is the power belonging to a low price zone to which the early morning and night charge is applied. Moreover, there also occurs influence upon the sleeping time, and hence the load pattern is also influenced upon the time zone. If the demander examines the data of actual results of the last year and desires to reduce the living cost for a less expensive life, the demander will go to bed early in the night and will get up early in the morning. Moreover, the demander can set the power consumption and the target of charge value to lower values in an available range. Therefore, it is possible for the demander to compare economic effect between the life pattern in the past and that at present, and hence the demander can set a basic target to control his life.

<5> Furthermore, for the changed pattern thus set, the power consumption is not completely traced. In actual results, the value at each point of the pattern has deviation, namely, for a higher value and a lower value. When the actual results are higher in this situation, the shift from the expected pattern is achieved in a direction to minimize the available capacity of the facilities of the enterprise. Consequently, when the upper limit of the contracted pattern is exceeded, an extra charge is introduced and the unit price becomes also higher than that of the contracted power.

<6> Therefore, information of the extra charge of the unit price associated with the deviation from the pattern in actual results is also important information for the demander. Consequently, the demander modifies the items of the time zones and periods in which the unit price difference is large to create a modified pattern and sends the modified pattern to the enterprise. In response to the modified pattern, the enterprise uses the load pattern set by the demander as the basic data. The enterprise can attract attention of the viewer as follows. Data of extra charges due to the deviation from the pattern is displayed on a setting line associated with a largest value of extra charge or in the vicinity of the setting line. Moreover, data items are displayed in various colors or lines are drawn with various widths, or the like.

<7> Charge information based on the re-changed pattern modified by the information of unit price difference is then presented to the demander. Furthermore, in addition to the presentation of the information of unit price difference, charge value information calculated on assumption that the charge value is calculated according to a direct contract between the demander and the existing power company or information of difference amount regarding the amount difference with respect to the charge value of the existing power company in this case is returned to the demander. As a result of the operation, the economic advantage of the demander is clearly displayed as an amount, and when the value is greater, the development or introduction of distributed power supply is strongly promoted.

<8> In this step, the contract is finally set, and a period of time to settle the bank account is selected and is set, or use of a prepaid system or the total settlement is set.

In the embodiment, it is possible to confirm a load pattern, charge value information, and information of change in unit prices associated with difference between actual values and expected values which are determined according to the flow. Therefore, this is favorable for the interest of the demander as well as for the gathering of demanders of the enterprise and the creation of a load operation plan of power generating facilities of the enterprise, and hence yields profit for the demanders and the enterprise.

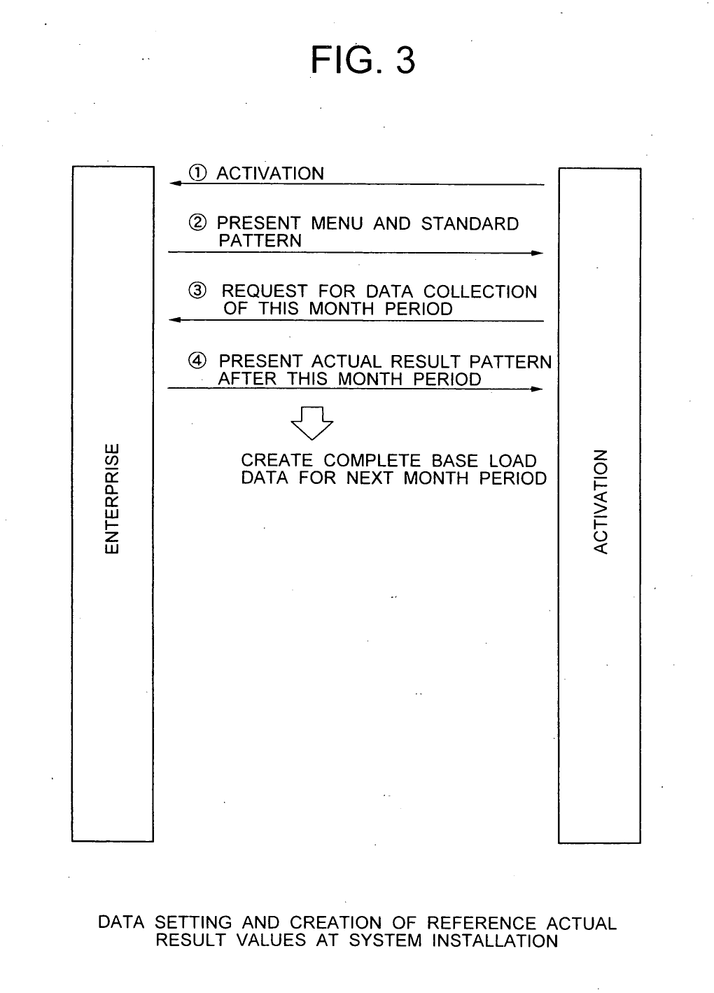

FIG. 3 shows a flow to set data and a flow to create reference actual values in the embodiment. In the flow, on assumption that actual results data is insufficient on the member side, a data sample beforehand possessed by the enterprise is presented, to the demander, as standard data (a standard pattern), for example, a mean value, a central value, or the like. Thereafter, the demander requests to collect own data of the pertinent month (period) according to intentions of the demander, and requests presentation of actual result data after completion of the contract period of the this month (period), and uses the data for the operation described above.

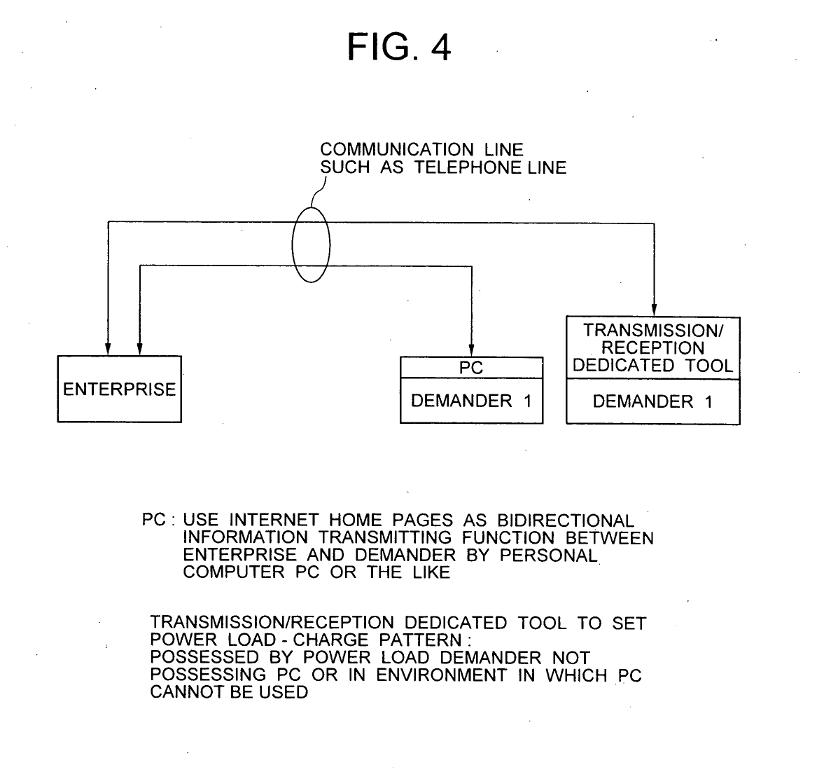

FIG. 4 shows data communication lines between the enterprise and demanders and a data communication tool in the embodiment. Telephone lines and the like are used as information communication lines between the enterprise and a plurality of demanders, and as an example of communication tools on the demander side, a personal computer (PC) and a tool dedicated for reception and transmission are connected to the system. In this connection, the communication system may be configured such that a homepage of the internet is opened and a bidirectional information link is established therein.

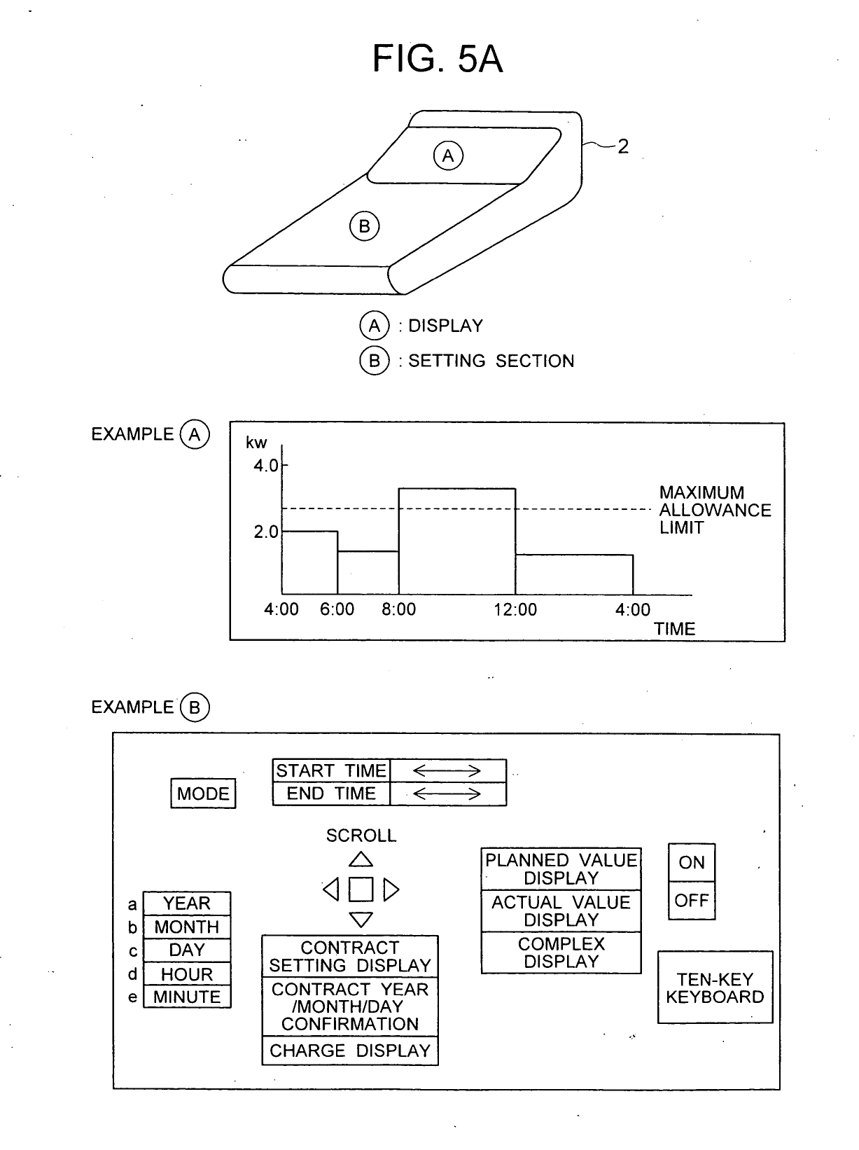

FIG. 5 shows a tool as a dedicated information terminal of the embodiment. FIG. 5(a) shows an appearance of the tool and a display section and a setting section thereof. In this diagram, only the setting of a load pattern is shown, and display of a charge value is not shown. Example A is a load pattern in a case in which the load pattern is drawn for respective time zones of a day. The load pattern is associated with a condition that the demander is present or absent in the house and that the electric upper-limit capacity of the power distribution facility associated with the power consumption facilities is restricted, and hence a line thereof is shown. In general, it is assumed that the facilities for the family distributing system used in the contract with an existing power company are also used in this system. Therefore, the setting must be conducted in consideration of the upper-limit capacity of the 30A contract which will not cause a fire. Any setting of a value exceeding this value is assumed as invalid. This is an essential requirement. Example B shows a setting section in which operations corresponding to items regarding the contents of the display section are conducted. This section is used to conduct operation to set a target period to be set, operation to set a load power for each period partition, operation to display charge values for a defined load pattern, operation to display values of actual results, and any associated operations. FIG. 5(b) is a diagram of an image showing the display section and the setting section.

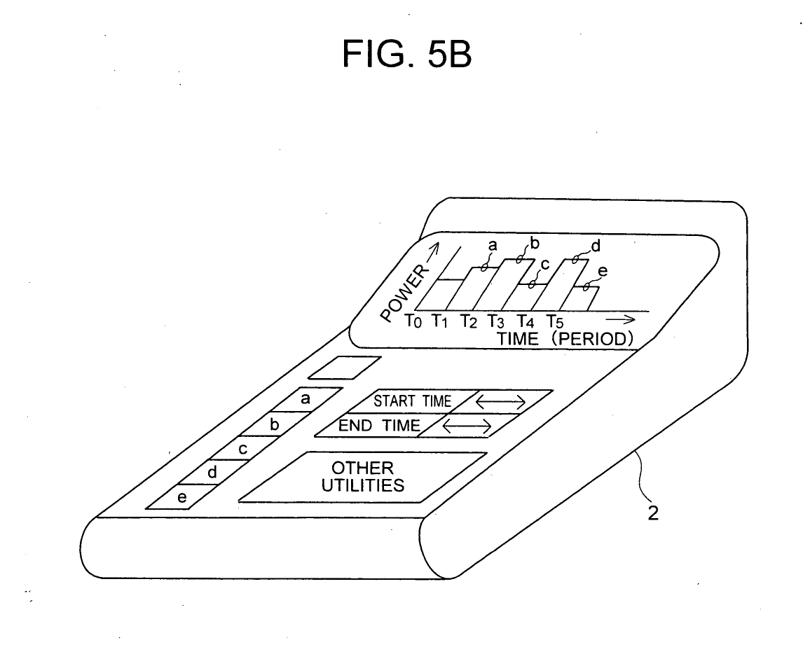

Referring to FIG. 6, description will be given of a point of time at which the load pattern is determined (fixed) in the embodiment. In the determination of an expected load pattern, it is necessary to determine (fixe) a load pattern before a start point of time of use of the expected pattern.

In FIG. 6, the present point of time exists in a period A, and it is desired to set a period B. Assume that a latest determination point for the setting of the period B is represented as Tend (pattern determination end limit). The point of time is set by the enterprise side. For the setting at a point of time exceeding the point of time, there exists rules in the basic contract to purchase power, for example, an extra charge is assigned or the setting is automatically conducted in the same way as for the previous setting. In some cases, it is assumed that a procedure of a subsequent stage is prepared in advance such that the successive fixed load at the upper-limit capacity of the facilities is automatically set. To achieve rationalization by setting the pattern is the inherent object of the present invention. If the setting action cannot be achieved for some reasons, the substitution procedure must be conducted as described above.

On the other hand, the power company of distributed power supply desires to develop business by completely using the capacity of the facilities thereof. Therefore, excepting the maintenance period, the profit is in general higher, when the facility operating rate (the load rate of power generating facilities) is higher. Under this condition, while the pattern setting are increasingly executed for many power demanders, if it is determined at a point of time near the contract determination limit that the assumed or expected load rate is not realized, it is possible during the remaining period to set a spot price to a reduced value. This is conducted to increase the facility operation rate. General demanders can wait for this period to sign a contract of the spot charge. However, conversely, in the change of the relationship between supply and demand, if the facility rate is in the vicinity of the upper-limit capacity at an early point of time, the spot price may be set to a higher value. The power demander checks the power utilization state in the pertinent season and the time zone, and can combine the pattern with a fixed load pattern if the demander consider the combination is rational.

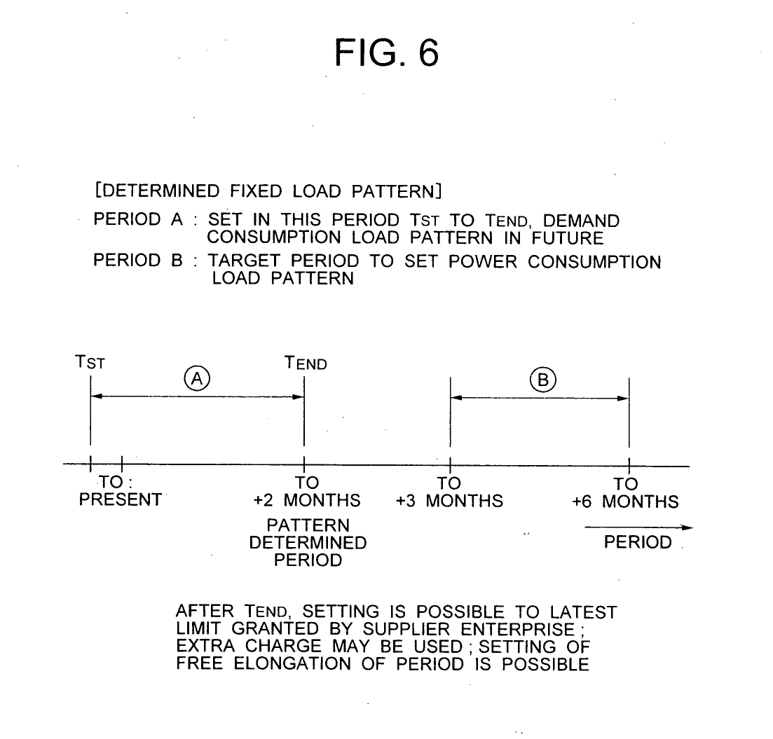

FIG. 7 shows a load pattern example viewed from the enterprise side of the spot supply. The ordinate represents the total demand associated with the pattern load and the abscissa represents the power generation capacity as power generating facilities. Presented along the abscissa are the total (accumulated) value of load pattern, marginal capacity, and a time zone to disclose information for possibility of spot supply.

In this example, the enterprise has power supply capacity according to the power generation capacity of the power generating facilities under control of (or possessed by) the enterprise including additional power supply capacity resultant from the selling of power from another power company. For a fixed period of time in future (for example, when demand of a demander selected fixed pattern #1 cannot be expected) in which the supply capacity has marginal capacity, a setting period (time) and a unit price are impartially presented to demanders, which makes it possible to sign a spot contract.

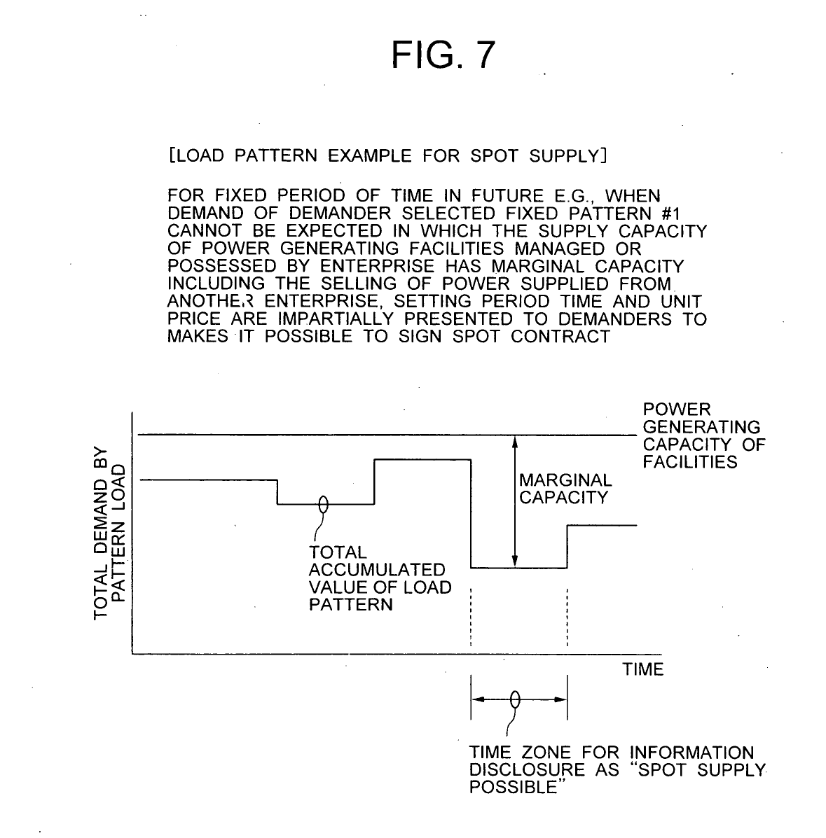

FIG. 8 shows a total load pattern of a combination of a determined load pattern and a spot supply viewed from demanders.

In this case, by referring to the time zone in which the spot supply is possible as shown in FIG. 7, the spot supply is added to the determined load pattern during the period A shown in FIG. 6 to set the total load pattern.

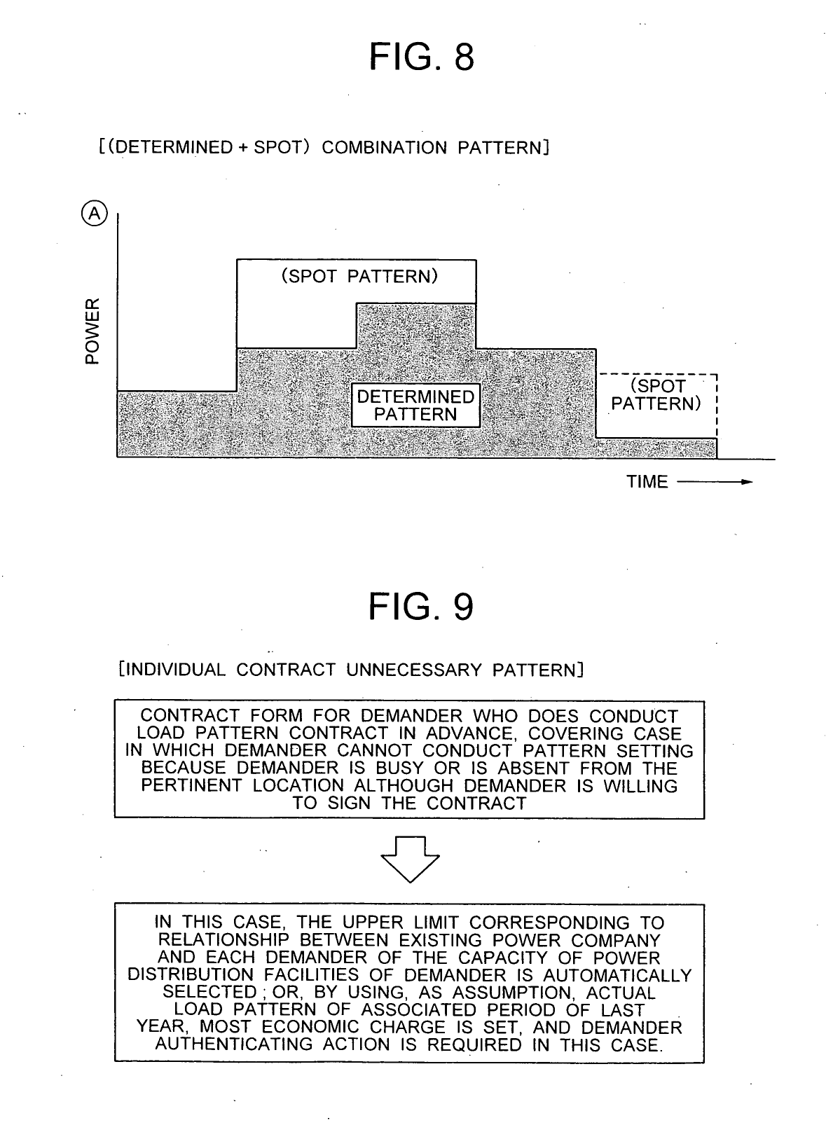

FIG. 9 shows a case in which the contract of the individual load pattern is not required or is not possible. Although the description is partly duplicated, there exists a case for a demander who is not intended to contract the load pattern in advance. Moreover, there may exists a case in which the demander cannot conduct the pattern setting because the demander is quite busy or is absent from the pertinent location although the demander is willing to sign the contract. In this case, the upper limit (corresponding to a relationship between an existing power company and each demander) of the capacity of power distribution facilities of the demander is automatically selected. Alternatively, by using, as assumption, the actual load pattern of the associated period of the previous year (or the previous month), there is produce a power consumption estimation which is considered to be most reliable. According to the power consumption estimation, the charge setting operation is conducted. In this situation, a demander authenticating action is required. This corresponds to an action in which the pattern in the past described above is confirmed on the display screen and then a similar setting is conducted as a new setting for the charge.

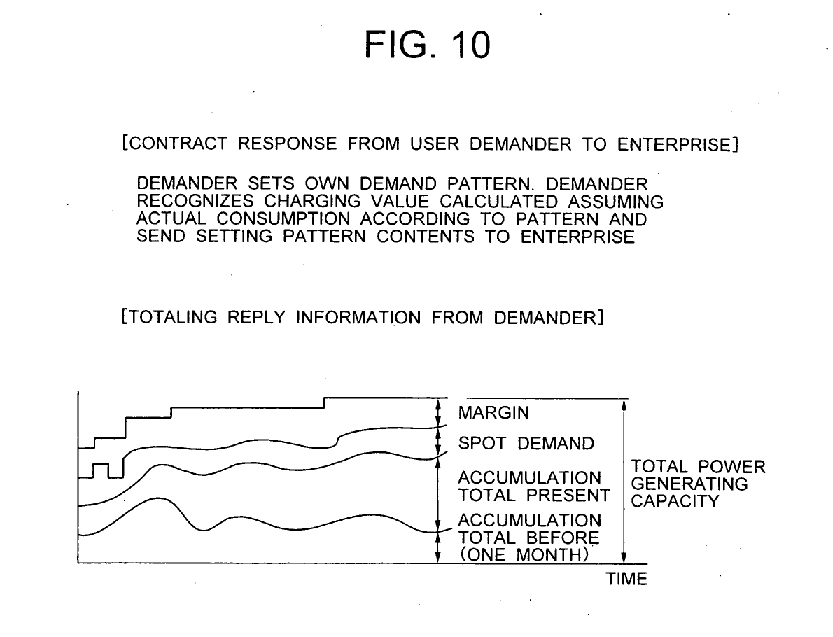

Referring to FIG. 10, description will be given of the contents of the processing on the enterprise side. Each demander sets a demand pattern according to intention of the demander, recognizes a charge value assuming actual results of consumption according to the pattern, and returns the contents of the pattern thus set to the enterprise to thereby sign a contract. The data itself used in this operation sent from each demander is accumulated as accumulated value data on the enterprise side. The enterprise can display the accumulated data together with the spot demand as a curve changing with respect to time, and it is possible to confirm margin viewed from scheduled total power generation capacity. In FIG. 10, a summary or total of information returned from demanders shows summary of accumulated information at this point of time and that of the last month, including subordinate information to forecast changes thereof up to a final determination point of time. This is provided for the following reasons. The enterprise side can flexibly develop businesses by paying attention to the setting change made by each demander as a customer according to uncertain environmental variations such as the weather and to accidental and overall trends of arbitrary operation for a point of time to determine the contract contents.

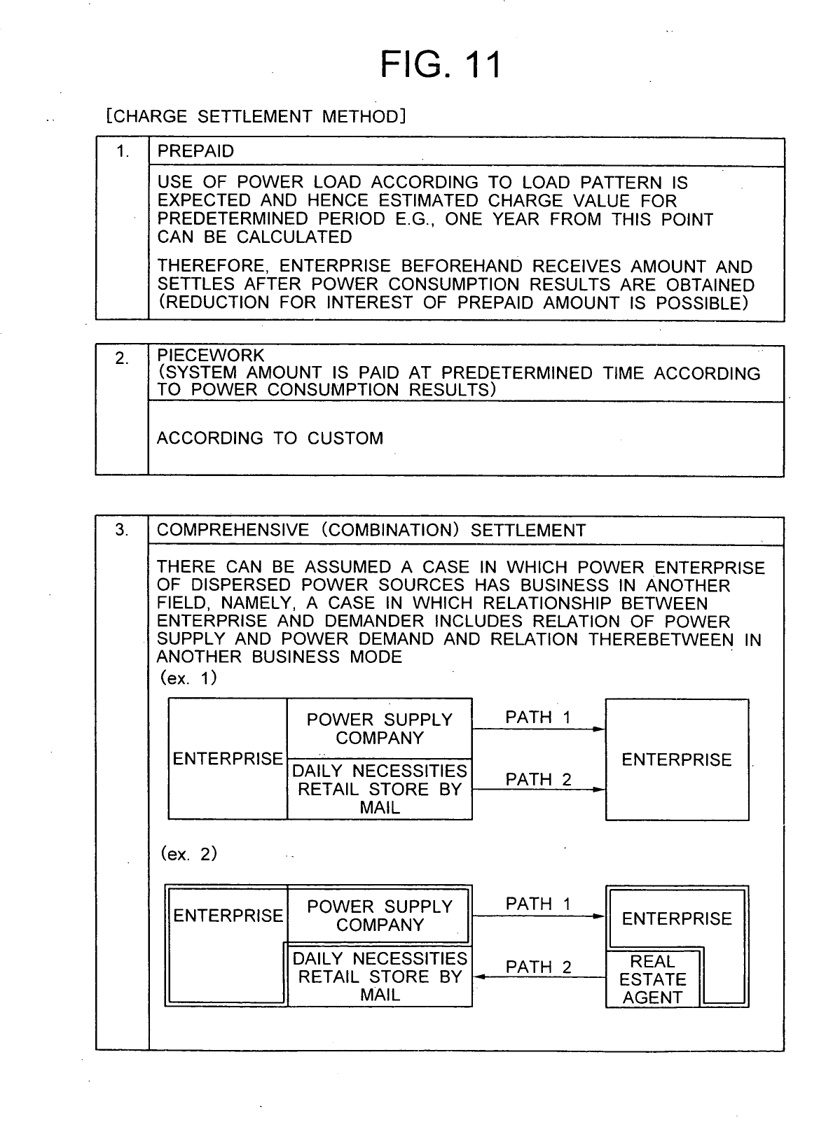

FIG. 11 shows a charge settlement method associated with a charge paying method. As shown in FIG. 11, (1) assuming electronic processing of planned power utilization and charge value thereof, it is possible to introduce a prepaid method. Additionally, (2) it is natural that the payment after determined results can be used as in the prior art (piecework system).

In the prepaid method, for a demander having surplus money, discount of the interest on the prepaid amount may be allowed, or this method may be treated as “item” in a step of a strategic approach for the enterprise to gather demanders. Incidentally, when the prepaid amount is less than the amount of power actually used, the rest of the amount is to be settled later. However, such an amount is only a difference from an initially forecast amount and hence it does not lead to a temporary heavy load on the demander. That is, this method can be regarded as rational.

Furthermore, referring to FIG. 11, description will be given of (3) a comprehensive (combination) settlement method. This is applied to a variation of a complex mode including a case in which a relationship between the power company using distributed power supply and the power demander is applied not only to a business limited to the fundamental utility “electric power”. That is, there exist also a case in which the enterprise also has a second company of another kind and a case in which the power company using distributed power supply stands on the customer side for second company described above.

For example, when the power company using distributed power supply has a daily necessities retail store by mail, the company is a customer of the store. For the relationship between the enterprise and the customer (demander), there exist two kinds of paths. In this situation, only if the settlement method is in detail determined, there does not occur any essential problem in the comprehensive settlement. It can be rather considered that the commercial transaction like the mail-order sales is a more rational mode of business for the life because transmission and confirmation of intention of purchase can be achieved via electronic media in the present social situations. Moreover, in the relationship between the power company using distributed power supply and a demander who is a real estate enterprise, when the enterprise as a demander of the real estate agent lends an office therefrom, there also exist two kinds of paths therebetween. In this case, a relationship of supply and demand mutually exists therebetween, the settlement can be achieved in the comprehensive settlement. The comprehensive settlement method can be easily implemented without any intervention of the banks ordinarily used only if the management of details and the settlement periods are clearly determined by the contract signed by both parties concerned.

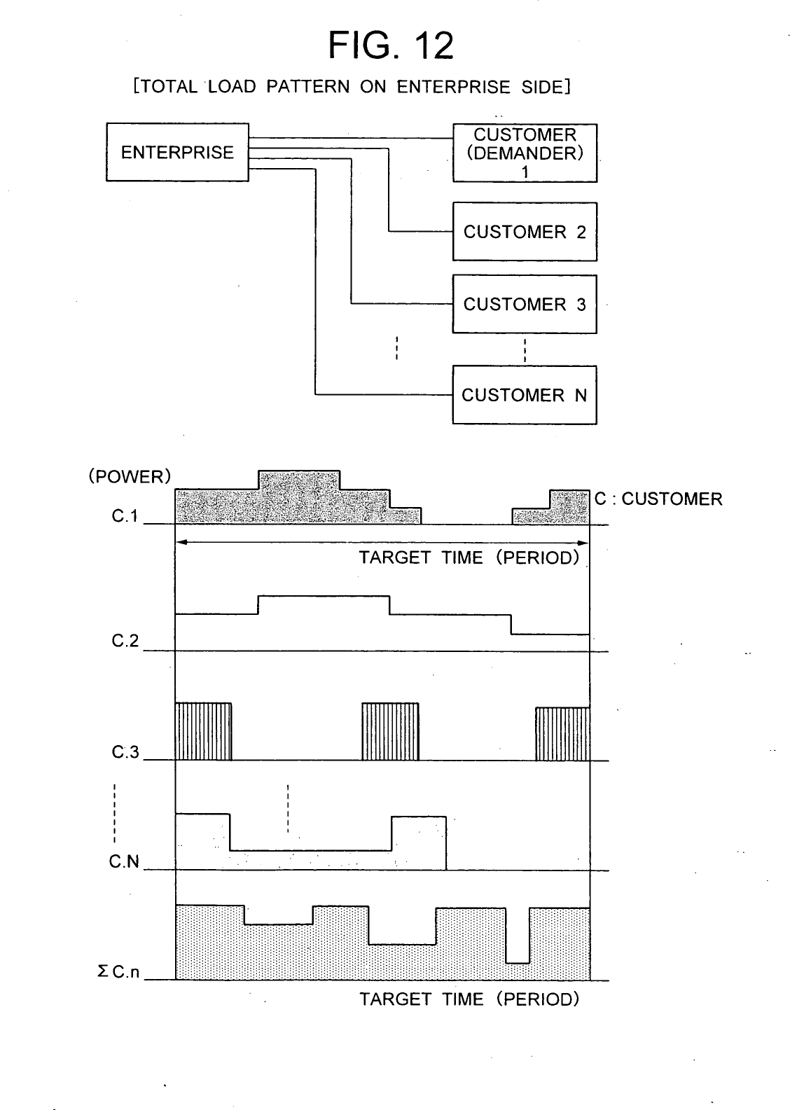

Next, referring to FIG. 12, description will be given of collection of load demands from a plurality of demanders of the power company using distributed power supply. Assume that demanders range from customer 1 to customer N and are represented as C.1 to CN, respectively. The abscissa represents periods (time) and the ordinate represent the power resultant from the collection of load patterns of each customer. Assume that the total thereof is expressed as ΣC.n. As a result, the total (in the management units) of demander load patterns of the enterprise is known as above. The value can be used as fundamental data for the enterprise to create a facility operation plan, a facility maintenance plan, a standby generating facility preparation plan, a plan to set a power generation quantity and a unit price for the spot supply, and the like. The total value can also be employed as an index essential for important operations and management of the enterprise.

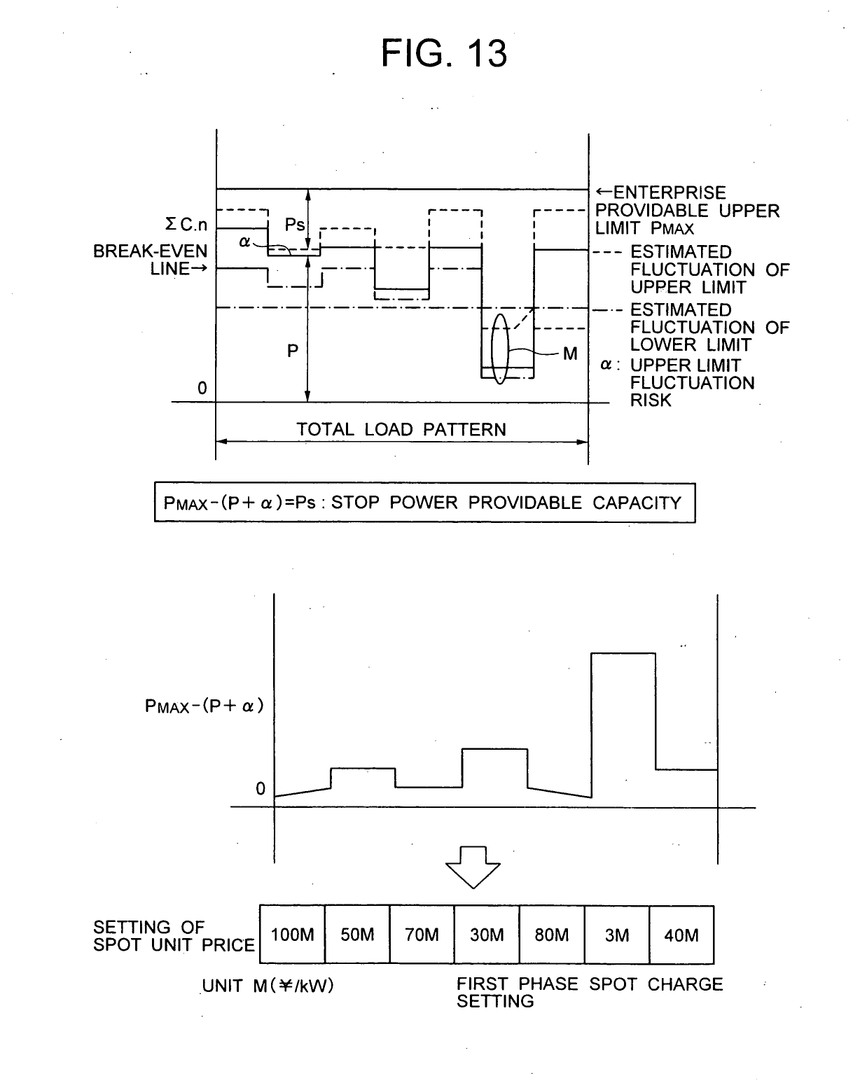

Description will now be given of significance of the fundamental data used to set a power generation quantity and a unit price for the spot supply by referring to FIG. 13.

In FIG. 13, a graph in an upper section thereof shows periods for enhancement of publicity to sell electric power in the business effort to exceed a break-even line of the own company according to the total load pattern obtained from FIG. 12. At the same time, the graph shows the spot supply capacity for each period. An expression Ps below the graph is a formula to approximate the spot power supply capacity. A broken line indicates an upper-limit deviation and a dotted line is a lower-limit deviation. These lines indicate expected values to flexibly cope with changes of the setting of contracts by the respective demanders. In FIG. 13, a region M is below the break-even line. That is, FIG. 13 implies necessity of the business effort for this period in the business activity. It is desired that this state is improved, for example, by advertising a discount charge.

A graph in a lower section of FIG. 13 shows a spot charge setting example. Basically, using a Kw unit price coefficient M as a reference value, a higher unit price is set to a period of a higher demand and a lower unit price is set to a period of a lower demand. Under this condition, according to experiences, know-how, and the like of the enterprise, the unit price is strategically set.

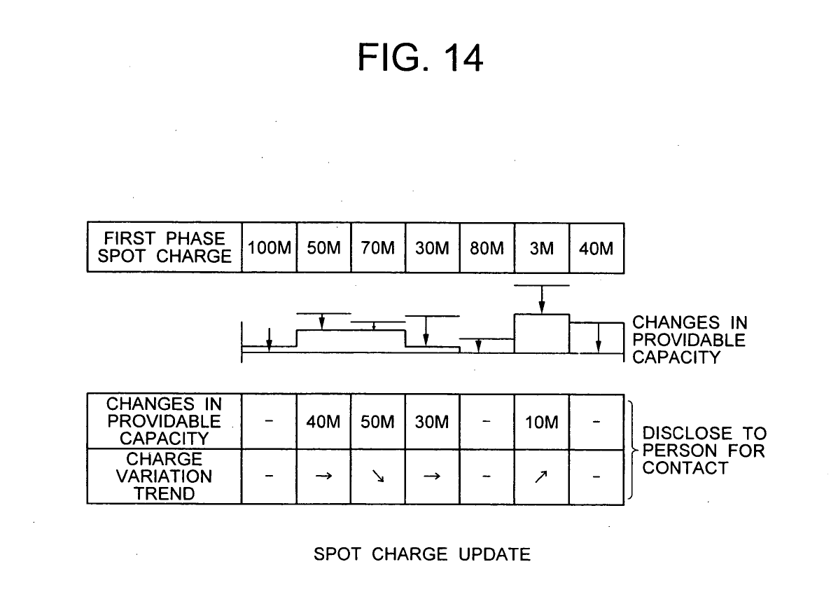

A table in a lowest section of FIG. 13 is a spot charge setting table. In the table, “first phase” is used such that the spot charge can be variably set according to a period difference of the period of time up to the actual operation time. In FIG. 14, “second phase” is provided such that by recognizing a degree of change in data of supply capacity margin at a region setting point, the charge is set in association with a trend of the change. The final purpose is to finally set the unnecessary standby capacity to zero.

As above, in the embodiment, the system can cope with difficulties by controlling the charge. Therefore, it is possible to lead to optimization in association with the contract and the management and the family budget respectively on the enterprise side and the demander side.

Subsequently, description will be given of part of hardware as an apparatus necessary to create a power utilization actual result pattern of each demander. The hardware is an apparatus necessary to examine a power utilization actual result pattern as history data in the past which each demander using the personal computer and the dedicated tool described above refers to when the demander sets own data as well as to examine part of the fundamental data necessary when the enterprise checks actual results of execution of contracts of demanders for the following reasons. The watthourmeter (to measure watt time integral value) installed heretofore for each family cannot obtain watt pattern data depending on cases and/or the facilities possessed by the existing power company in the form of enterprise cannot arbitrarily used.

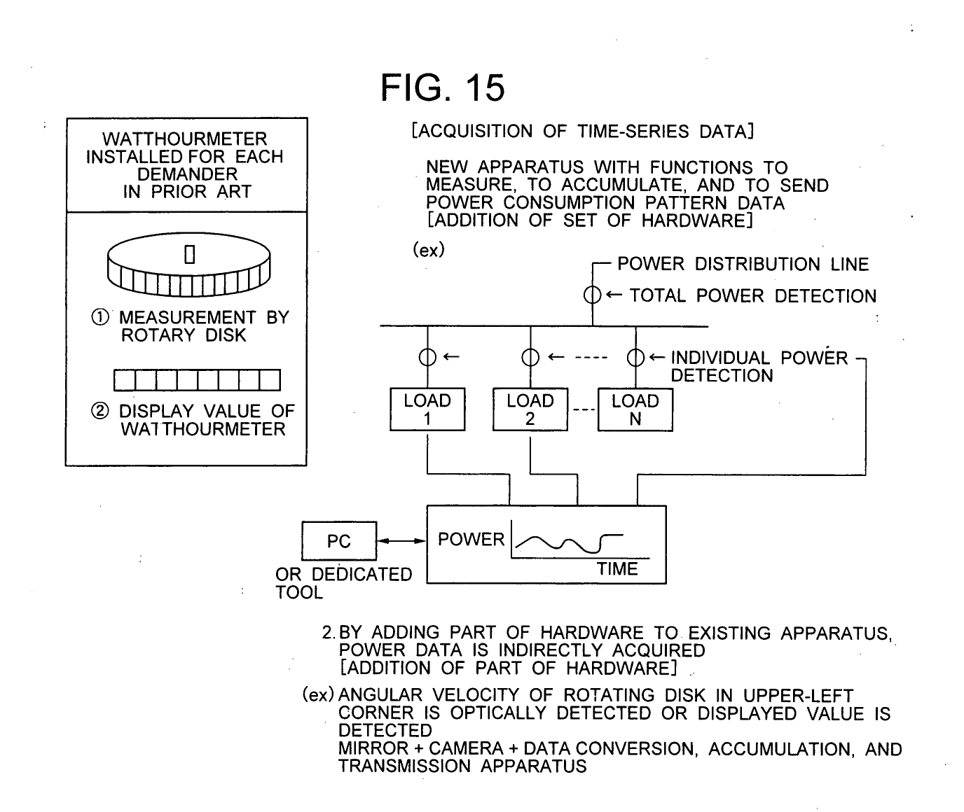

The hardware as the apparatus is implemented in either one of the following methods. That is, hardware corresponding to the meter is installed; the existing meter is partly modified, or the measured value of the existing meter is read in a physically contactless way. In this connection, FIG. 15 shows an example in which the measured value of the existing meter is read in an optical, contactless way.

The apparatus shown in FIG. 15 is an apparatus to acquire time-series power data. Description will be given of the apparatus on assumption that the apparatus employs features of the conventional watthourmeter, namely, a mechanism of measurement using a rotating disk and a mechanism to numerically display a value obtained by converting the number of rotations of the disk. In the meter installed to display power, the numeric value displayed increases sequentially, and the rotating disk is a pre-stage of the mechanism and conducts ordinarily one marking operation of one position per rotation. Therefore, by applying either one of the mechanisms which can be visually recognized, it is possible to reversely calculate the displayed value of electric energy to obtain a value of power. The apparatus shown in FIG. 15 employs this principle.

In the description, “the measured value of the existing meter is read in an optical, contactless way” indicates that the contents displayed by the meter is obtained by use of reflection of a mirror surface or by directly shooting the meter by a camera. Video information thus obtained is used to recognize a pattern according to a change in the numeric value or the number of rotations, and a value resultant from the pattern recognition is differentiated to recognize the information as a value of power.

Additionally, for the usability of the operator or the user, there can be considered a case in which a load pattern is discussed after the budget is determined. Therefore, when an initial load pattern set by a demander cannot be implemented within the budget, it is necessary to obtain a reference for the operation for modification. For this purpose, the period and power point associated with the budget can be marked. Using information thus marked, the demander can easily modify the own setting in a minimizing direction.

Next, electric power belongs to fundamental utilities indispensable for public interest, and hence if a trade of the charge is possible with the charge of other public utilities, the system will become rational. For example, assume that in the same energy type, the public utility of (urban) gas takes a similar contract mode as for the electric power and a particular demander pays the charge value to a particular company. When an excess portion of power is treated as a charge value of the gas charge associated therewith, there advantageously arises flexibility in the payment by the demander.

As described above, according to the present invention, it is possible to conduct operation with a possibly highest capacity of the power generating facilities, which has been impossible in the almost fixed charge system between the power supply and the power demand of the prior art. It is therefore possible to implement a flexible and rational power consumption mode. Additionally, the optimization effort of the demander side to minimize his or her expenses in the process of the operation can be reflected in the minimization of expenditures. This therefore contributes to the strengthening of independence of the own life pattern, and minimization of waste is also related to suppression of adverse influences upon an environment necessary for power plants. There can resultantly be created a good situation viewed from a social viewpoint.

Furthermore, the present invention contributes to the minimization of the capital investment for facilities in the existing power companies and to an advantage that the relation between supply and demand can be determined with high precision between the enterprise using distributed power supply and the general power demanders. This is advantageous for the creation of the business project, that is, the margin of the standby capacity of power generating facilities can be reduced. Moreover, the feat of minimization of the capacity margin in the highest power consumption period every year can be removed, and reliability of wide-range power business operation can be improved.

Moreover, at the same time, since the power generating facilities have highest efficiency at a rated point in ordinary cases, chances of undesired prohibition of activation of the facility and operation with a lowered load are minimized. This therefore leads to an advantage of improvement of the overall operation efficiency in a wide range. In addition, this also leads to an advantage, in consideration of activities against the environment problem which are required for the existing power companies and which also belongs to social missions, to reduce the total volume of harmful substances emitted in the atmosphere on the surface of the earth and also possibly leads to reduction of the electric charge.

Additionally, electric power belongs to utilities indispensable for public interest, and hence if a trade of the charge is possible with the charge of other public utilities, a particular demander can pay the charge value to a particular company, which advantageously leads to flexibility in the payment by the demander.

While the present invention has been described in detail and pictorially in the accompanying drawings, it is not limited to such details since many changes and modifications' recognizable to those of ordinary skill in the art may be made to the invention without departing from the spirit and scope thereof.

1-11. cancelled

12. A power contract support system for an enterprise of a power supply business, comprising:
an information apparatus to be connected via a communication line to an information apparatus of each of a plurality of demanders of electric power;
wherein said information apparatus of said enterprise
supplies information of contract periods and information of a charge price per unit of power for each of said contract periods via the communication line to the information apparatus of each of said demanders;
receives a load pattern of a contract period inputted via the communication line from said information apparatus of each said demander;
produces information of a charge price for the load patterns thus received and supplies the information of the charge price via the communication line to said information apparatus of each said demander;
receives a request of application inputted from said information apparatus of each said demander for a power supply contract for the information of charge price via the communication line; and
totals load patterns of a plurality of demanders having signed the power supply contract and calculates a margin according to time based on a total of said load patterns and a total power generating capacity of said enterprise.

13. A power contract support system for an enterprise of a power supply business, comprising:
an information apparatus to be connected via a communication line to an information apparatus of each of a plurality of demanders of electric power;
wherein said information apparatus of said enterprise
supplies information of contract periods and information of a charge price per unit of power for each of said contract periods via the communication line to the information apparatus of each of said demanders;
receives a load pattern of a contract period inputted via the communication line from said information apparatus of each said demander;
produces information of charge price for the load patterns thus received and supplies the information of the charge price via the communication line to said information apparatus of each said demander; and
receives a request of an application inputted from said information apparatus of each said demander for a power supply contract for the information of charge price via the communication line and thereby results in signing of the power supply contract.

14. A power contract support system for an enterprise of a power supply business, comprising:
an information apparatus to be connected via a communication line to an information apparatus of each of a plurality of demanders of electric power;
wherein said information apparatus of said enterprise
receives a load pattern of a contract period inputted from said information apparatus of each of said demanders via the communication line; and
totals load patterns of a plurality of demanders having signed a power supply contract and calculates a margin according to time based on a total of said load patterns and a total power generating capacity of said enterprise.
